(19) United States
(12) Patent Application Publication
(10) Pub. No.: US 2011/0142093 A1
(43) Pub. Date: Jun. 16, 2011

(54) LOW VOLTAGE MIXER CIRCUIT FOR A UWB SIGNAL TRANSMISSION DEVICE

(75) Inventor: Luca De Rosa, Colombier (CH)

(73) Assignee: THE SWATCH GROUP RESEARCH AND DEVELOPMENT LTD, Marin (CH)

(21) Appl. No.: 12/963,248

(22) Filed: Dec. 8, 2010

(30) Foreign Application Priority Data
Dec. 16, 2009 (EP) 09179458.6

(51) Int. Cl. H04B 1/00; G06G 7/16

(52) U.S. Cl. 375/130; 327/356; 327/359; 375/E01.001

(57) ABSTRACT

The low voltage mixer circuit can be fitted to a UWB signal transmission device. The circuit includes first and second differential pairs of NMOS transistors (M5, M6, M7, M8), wherein the source of the transistors (M5, M6) of the first pair is connected to the output of a first MOS transistor reverser arrangement (M1, M3) of a transconductance stage, and the source of the transistors (M7, M8) of the second pair is connected to the output of a second MOS transistor reverser arrangement (M2, M4) of the transconductance stage. The drain of the first NMOS transistor (M5) of the first pair and the drain of the second NMOS transistor (M7) of the second pair are connected to a first resistor (R0) for supplying a first output signal (RF0). The drain of the first NMOS transistor (M8) of the second pair and the drain of the second transistor (M6) of the first pair are connected to a second resistor (R1) for supplying a second output signal (RF1). The first and second resistors are connected to the high potential terminal (VDD) of the supply voltage source. The gate of the first NMOS transistors (M5, M8) of the differential pairs receives a first carrier frequency signal (LOP), whereas the gate of the second NMOS transistors (M6, M7) of the differential pairs receives a second carrier frequency signal (LON). A first data signal (IN0) is supplied to the input of the first reverser arrangement (M1, M3), whereas a second data signal (IN1) is supplied to the input of the second reverser arrangement (M2, M4).

This application claims priority from European Patent Application No. 09179458.6 filed Dec. 16, 2009, the entire disclosure of which is incorporated herein by reference.

### FIELD OF THE INVENTION

The invention concerns a low voltage mixer circuit for high frequency conversion of signals to be transmitted by an antenna, in particular for an ultra wide band (UWB) signal transmission device.

### BACKGROUND OF THE INVENTION

In a system using ultra wide band (UWB) technology, data transmission is performed via UWB data signals, which include a series of very short pulses with or without the use of a carrier frequency. “Data” should generally be understood to include textual information including one or more successive symbols, synchronisation information or other information. As the pulses are very short, for example each of a duration of 2 ns or less, this produces an ultra wide band spectrum in the frequency domain. For UWB technology, the defined frequency spectrum of UWB signals has to be between 3.1 and 10.6 GHz. The spectrum may also be divided into several frequency bands to define different transmission channels including 12 frequency bands of around 499.2 MHz.

For the UWB transmitter device to be recognised by a nearby UWB receiver device, the pulse sequence coding of the transmitted data signals is in theory personalised to the transmitter device. Different types of coding can be used for transmitting data in UWB signals. Pulse position modulation (PPM), pulse amplitude modulation (PAM), binary phase or phase shift keying (BPSK), a combination of pulse position modulation and phase shift keying, binary On-Off-Keying (OOK) coding or another type of modulation can be used. Data transmission by ultra wide band technology is normally carried out at a short distance with low power transmitted pulses.

The data pulses are generated in a pulse generation circuit controlled by a data generator of the UWB signal transmission device for supplying at least one data pulse signal. This pulse signal for the UWB signals can still be frequency converted via a mixer. This pulse signal is thus mixed in the mixer with at least one carrier frequency signal from a local oscillator. The signals provided by the mixer generally have to be amplified in an additional amplifier, as the transmission dynamic range at the mixer output is often insufficient. The signals amplified by the amplifier define the UWB signals to be transmitted by the transmission device antenna. This constitutes a drawback of this type of prior art device, since it means that neither the number of components nor the electrical power consumption of the device can be reduced.

One embodiment of a mixer circuit used in a UWB signal transmission device is defined in JP Patent No. 2005-184141. This mixer circuit converts data signals at a high frequency for the transmission of UWB signals. The mixer circuit is made such that it can operate at a low voltage for example at a voltage of less than 2 V. To achieve this, it includes two differential pairs of MOS transistors each series connected with another MOS transistor and a resistor between the terminals of a supply voltage source. This enables the level of said supply voltage to be reduced. However, the mixer circuit does not supply output signals with a sufficient dynamic range. This thus requires the use of an amplifier at the mixer circuit output to amplify the output signals for UWB signal transmission, which constitutes a drawback.

One improvement to the mixer circuit of the previous document is disclosed in US Patent No. 2009/0174460. The mixer circuit of this document also includes two differential pairs of NMOS transistors each series-connected with another NMOS transistor and a resistor between the terminals of a supply voltage source. Each NMOS transistor connected to the corresponding differential pair of NMOS transistors is adapted to remove the third order transconductance to obtain a more linear mixer circuit. Even if the mixer circuit can be arranged to operate at a low voltage, it is nonetheless also necessary to use an amplifier at the mixer circuit output to amplify the output signals for UWB signal transmission, which constitutes a drawback.

US Patent No. 2006/0135109 also discloses a mixer circuit with the same structure as in JP Patent No. 2005-184141 and US Patent No. 2009/0174460, but with two reverser arrangements in the transconductance stage. However, this mixer circuit uses an active load for supplying the two output signals, which constitutes a drawback, since this means that a good dynamic range cannot be guaranteed at the mixer circuit output.

### SUMMARY OF THE INVENTION

It is thus an object of the invention to overcome the aforecited drawbacks by providing a low voltage mixer circuit particularly for a UWB signal transmission device that ensures a maximum dynamic range at the low voltage mixer circuit output.

The invention therefore concerns the aforecited low voltage mixer circuit, which is a low voltage mixer circuit, particularly for a UWB signal transmission device, the mixer circuit including:
a transconductance stage, which includes a reverser transistor arrangement with an NMOS transistor series-connected with a PMOS transistor between two terminals of a supply voltage source, the drain of the NMOS transistor being connected to the drain of the PMOS transistor to define a transconductance stage output connection node, the gate of the NMOS transistor being connected to the gate of the PMOS transistor for receiving a data signal;
at least one transistor, wherein a first current terminal is connected to a connection node of the transconductance stage, a second current terminal is connected to an impedance for supplying an output signal, and a transistor control terminal is arranged for receiving a signal from an oscillator,
the transistor connected to the connection node of the transconductance stage, and the impedance being series-connected between two terminals of a supply voltage source,

wherein it is integrated in a silicon substrate, wherein the substrate or well potential of the NMOS transistor of the transconductance stage is set at a first potential adapted between the low potential and the high potential of the supply voltage source, and wherein the substrate or well potential of the PMOS transistor of the transconductance stage is set at a second potential adapted between the low potential and the high potential of the supply voltage source.

Particular embodiments of the mixer circuit are defined in the dependent claims 2 to 9.

One advantage of the low voltage mixer circuit lies in the fact that the voltage amplitude of the mixer circuit output signal or signals is increased because of the transconductance stage with a low supply voltage. This provides a maximum dynamic range at the mixer circuit output even with a supply voltage of less than 1 V. To achieve this, only two transistors are series-connected between the two terminals of the supply voltage source, for the transconductance stage and for the arrangement between the transconductance stage and the differential pairs of transistors.

The invention therefore also concerns a UWB signal transmission device provided with a low voltage mixer circuit, which is. a UWB signal transmission device including a pulse generator circuit, which is combined with a data pulse or pulse burst position modulation and phase shift keying unit, a data generator for supplying digital control signals to the pulse generator circuit and the data pulse or pulse burst position modulation and phase shift keying unit, a local oscillator and a mixer circuit for receiving at least one data signal from the pulse generator circuit to be mixed with at least one carrier frequency signal from the local oscillator so as to supply directly at least one output signal to an antenna for the UWB signal transmission.

A particular embodiment of the UWB transmission device is defined in the dependent claim 11.

### BRIEF DESCRIPTION OF THE DRAWINGS

The objects, advantages and features of the low voltage mixer circuit in a UWB signal transmission device will appear more clearly in the following description of at least one non limiting embodiment illustrated by the drawings, in which;

FIG. 1 shows, in a simplified manner, a UWB signal transmission device, which includes a low voltage mixer circuit according to the invention,

FIG. 2 shows an embodiment of the low voltage mixer circuit according to the invention for a UWB signal transmission device, and

FIG. 3 shows a particular embodiment of the transconductance stage of the low voltage mixer circuit according to the invention.

### DETAILED DESCRIPTION OF THE PREFERRED EMBODIMENTS

In the following description, the particular elements of the low voltage mixer circuit are all defined. However, the method of making each element of said mixer circuit, which is well known to those skilled in this technical field, is described only in a simplified manner. Said low voltage mixer circuit may preferably be used in a UWB signal transmission device, but it may also be used in any other radiofrequency signal transmission or reception device for example.

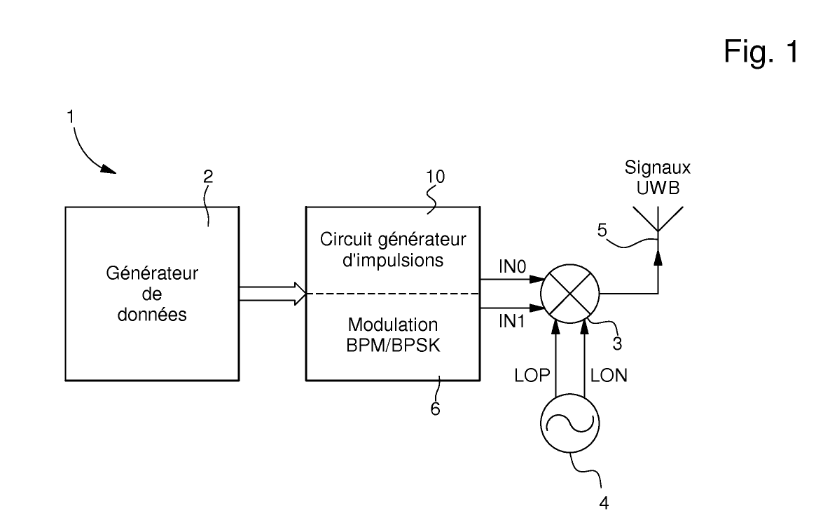

The UWB signal transmission device 1, which includes low voltage mixer circuit 3 according to the invention, is shown in a simplified manner in FIG. 1. This transmission device can be formed of a data generator 2, a pulse generator circuit 10, a BPM/BPSK modulation unit 6 combined with the pulse generator circuit, a local oscillator 4, a mixer circuit 3 according to the invention and an antenna 5 for transmitting the UWB signals.

The UWB carrier frequency signals, which are transmitted by the antenna, may be formed of a synchronisation preamble and a series of data symbols after the preamble. For each transmitted data symbol, the UWB signals include a pulse of less than 2 ns or a burst of position modulated and phase shifted pulses, defining two bits, and frequency converted on a carrier frequency of between 3.1 GHz and 10.6 GHz. The carrier frequency of the UWB signals can be determined, for data transmission, for example from among the twelve 499.2 MHz frequency bands within the 3.1 GHz and 10.6 GHz bandwidth of the UWB spectrum. A carrier frequency of 7.9872 GHz may be selected for example.

In the UWB signal transmission phase, data generator 2 supplies the digital data signals to the arrangement comprising position modulation (BPM) and binary phase shift keying (BPSK) unit 6 and pulse generator circuit 10. This allows the pulse generator circuit to supply at least one pulse output signal IN0 for mixer circuit 3. At least one carrier frequency signal LOP from local oscillator 4 is mixed with the pulse generator output signal in mixer circuit 3. This allows the output signal to be frequency converted onto the carrier frequency. The mixer circuit 3 thus supplies at least one output signal RF0 directly as pulse data UWB signals to transmission antenna 5 to be transmitted to at least one nearby receiver device.

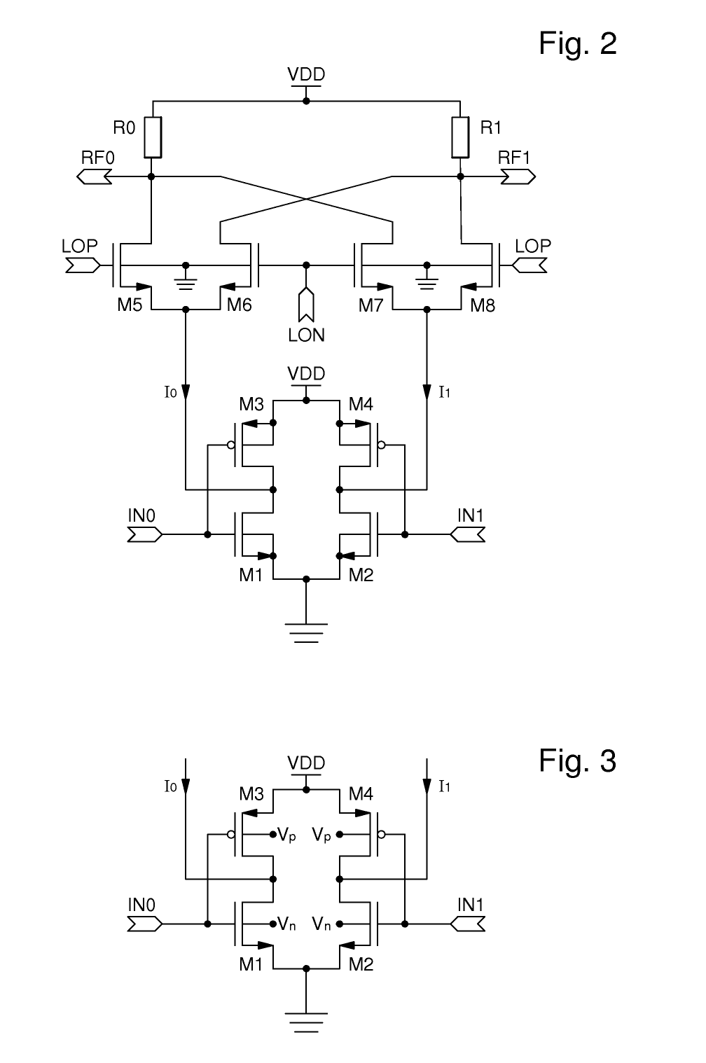

It is to be noted as explained below with reference to FIGS. 2 and 3 that mixer circuit 3 can preferably be configured to receive two pulse data output signals IN0 and IN1 from pulse generator circuit 10. The pulses of the first output signal IN0 are reversed relative to the pulses of the second output signal IN1. In mixer circuit 3, the first pulse output signal IN0 is mixed with a first carrier frequency signal LOP from local oscillator 4, whereas a second pulse output signal IN1 from the pulse generator circuit is mixed with a second carrier frequency signal LON. This second carrier frequency signal from local oscillator 4 is phase shifted 180° relative to the first carrier frequency signal. This thus reinforces the pulse UWB data signals to be transmitted by antenna 5 if the two differential outputs are combined. To achieve this, an adder for the mixer circuit output signals can be provided at the mixer output.

One embodiment of the low voltage mixer circuit of this invention is now described in more detail with reference to FIG. 2. This low voltage mixer circuit is preferably intended to form part of the UWB signal transmission device as explained above. It is powered by a low voltage power supply source, which may be less than 1 V, for example around 0.9 V. This considerably reduces the power consumption of the mixer circuit relative to those of the state of the art. This mixer circuit can be made in integrated form, for example in a P doped silicon substrate in 0.18 μm CMOS technology. It may be made in the same integrated circuit with the data generator, the BPM/BPSK modulation unit and the pulse generator circuit, and a large part of the local oscillator of the transmission device.

This low voltage mixer circuit includes two impedances, which are resistors R0, R1, two differential pairs of NMOS transistors M5, M6, M7 and M8 (first type of conductivity), which are of the same dimensions and matched, and a transconductance stage, formed of two branches of matched NMOS transistors M1, M2 and matched PMOS transistors M3, M4 (second type of conductivity). The first branch of the transconductance stage includes a first NMOS transistor M1, which is series-connected in the form of a reverser with a first PMOS transistor M3 between two terminals of a supply voltage source VDD (not shown). The second branch of the transconductance stage includes a second NMOS transistor M2, which is series-connected in the form of a reverser with a second PMOS transistor M4 between the two terminals of the supply voltage source. Each MOS transistor includes a first current terminal, which defines the source, a second current terminal, which defines the drain, a control terminal, which defines the gate, and a terminal which defines the well or substrate contact.

The source of the two NMOS transistors M1 and M2 is connected to the earth terminal, whereas the source of the two PMOS transistors M3, M4 is connected to the high potential terminal VDD of the supply voltage source. The drain of the first NMOS transistor M1 is connected to the drain of the first PMOS transistor M3 in the first branch to define a first connection node. The drain of the second NMOS transistor M2 is connected to the drain of the second PMOS transistor M4 in the second branch to define a second connection node. The gate of the first NMOS transistor M1 is connected, in a reverser arrangement, to the gate of the first PMOS transistor M3 to receive the first pulse output signal IN0 from the pulse generator circuit. Finally, the gate of the second NMOS transistor M2 is connected, in a reverser arrangement, to the gate of the second PMOS transistor M4 to receive the second pulse output signal IN1 from the pulse generator circuit.

The source of each NMOS transistor M5, M6 of the first differential pair is connected to the first connection node of the first NMOS transistor M1 and PMOS transistor M3 of the first branch of the transconductance stage. The source of each NMOS transistor M7, M8 of the second differential pair is connected to the second connection node of the second NMOS transistor M2 and PMOS transistor M4 of the second branch of the transconductance stage. The drain of the first NMOS transistor M5 of the first differential pair is connected to a first resistor R0, which is also connected to the high potential terminal VDD of the supply voltage source (not shown). The drain of the second NMOS transistor M6 of the first differential pair is connected to a second resistor R1, which is also connected to the high potential terminal VDD of the supply voltage source (not shown). The drain of the first NMOS transistor M8 of the second differential pair is connected to the second resistor R1. The drain of the second NMOS transistor M7 of the second differential pair is connected to the first resistor R0.

The gates of the first NMOS transistors M5 and M8 of the two differential pairs are connected for receiving a first carrier frequency signal LOP from the local oscillator. The gates of the second NMOS transistors M6 and M7 of the two differential pairs are connected for receiving a second carrier frequency signal LON from the local oscillator. The second, sinusoidal, carrier frequency signal LON is phase shifted 180° relative to the first, sinusoidal, carrier frequency signal LOP. Consequently, the first NMOS transistors M5 and M8 are made conductive, whereas the second NMOS transistors M6 and M7 are made non-conductive, when the first carrier frequency signal LOP is at a higher voltage level than the second carrier frequency signal LON. Conversely, the second NMOS transistors M6 and M7 are made conductive, whereas the first NMOS transistors M5 and M8 are made non-conductive, when the second carrier frequency signal LON is at a higher voltage level than the first carrier frequency signal LOP. Since the carrier frequency signals are sinusoidal, there is of course a non abrupt conduction transition between the first and second NMOS transistors of the differential pairs.

A first output signal RF0, which forms the UWB signals, is supplied to the connection node of the first resistor R0 with the first NMOS transistor M5 of the first differential pair and the second NMOS transistor M7 of the second differential pair. A second output signal RF1, which forms the UWB signals, is supplied to the connection node of the second resistor R1 with the first NMOS transistor M8 of the second differential pair and the second NMOS transistor M6 of the first differential pair.

When the first pulse output signal IN0 is at a high voltage level, for example close to VDD, the first NMOS transistor M1 is made conductive, whereas the first PMOS transistor M3 is made non conductive in this reverser arrangement. In this case, the second pulse output signal IN1 is at a low voltage level, for example close to earth. Thus, the second NMOS transistor M2 is made non conductive, whereas the second PMOS transistor M4 is made conductive in this reverser arrangement. A current I₀ flows through the first NMOS transistor M1 and through one of the NMOS transistors M5, M6 of the first differential pair. This current I₀ also flows either through first resistor R0, or second resistor R1 which has the same resistive value as the first resistance. The value of this current I₀ is dependent upon the value of each resistor R0, R1, which may be around 50 Ohms for adaptation to the antenna impedance. However, no current I₁ flows in the second differential pair of NMOS transistors M7, M8.

Conversely, when the second output signal IN1, is at a high voltage level, for example close to VDD, the second NMOS transistor M2 is made conductive, whereas the second PMOS transistor M4 is made non conductive. In this case, the first pulse output signal IN0 is at a low voltage level, for example close to earth, which means that the first NMOS transistor M1 is made non conductive, whereas the first PMOS transistor M3 is made conductive. Thus, a current I₁ flows through the second NMOS transistor M2 and through one of the NMOS transistors M7, M8 of the second differential pair. This current I₁ also flows either through the first resistor R0, or the second resistor R1. The value of current I₁ is dependent upon the value of each resistor R0, R1. However, no current I₀ flows in the first differential pair of NMOS transistors M5, M6.

The pulse output signals IN0 and IN1 supplied by the pulse generator circuit can be modulated with ternary data coding. In this case, when one of the pulse output signals is at the high state, a “1” state is defined, whereas when it is in the low state, close to earth, a “−1” state is defined. The “0” state is defined when the voltage level of the pulse output signals is at VDD/2. In this latter case, none of the MOS transistors of the transconductance stage is made conductive given that the gate voltage across each of the MOS transistors is less than the conduction threshold. Thus, the mixer circuit output signals RF0 and RF1 are close to the high potential VDD of the supply voltage source.

In this first embodiment of the mixer circuit shown in FIG. 2, the well or substrate potential of PMOS transistors M3 and M4 of the transconductance stage is set at high potential VDD of the supply voltage source. The substrate or well potential of the NMOS transistors M1 and M2 of the transconductance stage is set at the earth potential of the supply voltage source. The same is true for the substrate or well potential of the NMOS transistors M5, M6, M7 and M8 of the differential pairs as shown in FIG. 2. Since the integrated circuit of the mixer can be made in a P silicon substrate, it is therefore the well potential of the PMOS transistors, which is set at the high potential, whereas it is the substrate potential of the NMOS transistors which is set at the low potential.

The reverser arrangement of the NMOS and PMOS transistors in the two branches of the transconductance stage guarantees good amplification of the mixer circuit output signals RF0 and RF1. This thus ensures a large transmission dynamic range with a low supply voltage. In these conditions, it is not necessary to arrange another amplifier at the mixer circuit output for transmitting the UWB signals via the transmission device antenna.

The mixer circuit amplification can be also altered via the transconductance stage by acting on the substrate and well potential of the MOS transistors of the transconductance stage as illustrated in FIG. 3. It is to be noted that the transistors in FIG. 3, which are the same as those in FIG. 2, bear identical reference signs. Consequently, for the sake of simplification, the description of the transistors and the connection thereof to the differential pairs for current I₀ and I₁ will not be repeated.

By altering the substrate or well potential Vp of PMOS transistors M3 and M4 and/or the substrate or well potential Vn of NMOS transistors M1 and M2, it is possible to alter the amplification of the mixer circuit output signals RF0, RF1. This additional amplification gain on output signals RF0, RF1 avoids the need to arrange a signal amplifier at the mixer circuit output for providing the UWB signals to be transmitted. To show this influence of potential Vp and/or Vn of the transconductance stage MOS transistors, some voltage values are indicated in the table below. The mixer circuit supply voltage VDD is set at less than 1 V, for example at 0.9 V. This table indicates the maximum variation amplitude of output voltage Vout (RF0, RF1) as a function of substrate or well potential Vn of the NMOS transistors and substrate or well potential Vp of the PMOS transistors.

| | Vp PMOS = 0.5 V | Vp PMOS = VDD = 0.9 V |
|---|---|---|
| Vn NMOS [V] | Vout (RF0, RF1) [mV] | Vout (RF0, RF1) [mV] |
| −0.5 | 420 | 330 |
| −0.25 | 390 | 290 |
| 0 | 340 | 220 |
| 0.25 | 270 | 160 |
| 0.5 | 220 | 130 |

By way of example, the substrate potential Vn of the NMOS transistors can be set at the low potential of the supply voltage source, i.e. at 0 V. In this case, the amplitude of the mixer circuit output signals RF can be one and a half times greater for a PMOS transistor well potential Vp of 0.5 V compared to a PMOS transistor well potential of 0.9 V. The 0.9 V potential is high potential VDD of the supply voltage source. Of course, the same well potential must be applied to PMOS transistors M3 and M4. The same is true for the substrate potential of NMOS transistors M1 and M2.

It is also to be noted that the mixer circuit described above has a clearly linear structure. It is consequently very useful over a broad frequency range, which is why it is preferably used in a UWB signal transmission device. Moreover, since only sets of two MOS transistors are series-connected between the two terminals of the supply voltage source, the mixer circuit can be powered at a very low voltage, below 1 V, for example 0.9 V.

Of course, it is possible to envisage connecting all the components described in FIG. 2 in reverse. However, all of the NMOS transistors in FIG. 2 must be replaced by PMOS transistors, and all of the PMOS transistors in FIG. 2 must be replaced by NMOS transistors. The resistors are however connected to the low potential terminal of the supply voltage source.

It is also possible to envisage using impedances other than just resistors. A first inductance can replace the first resistor and a second inductance can replace the second resistor. A combination of a resistor in parallel or series with an inductance can also be envisaged.

From the description that has just been given, those skilled in the art can devise several variants of the low voltage mixer circuit, particularly in a UWB signal transmission device, without departing from the scope of the invention defined by the claims. Bipolar transistors can be used instead of MOS transistors. In these conditions, each PMOS transistor of a first type of conductivity or second type of conductivity is replaced by a PNP transistor, whereas each NMOS transistor of a second type of conductivity or a first type of conductivity is replaced by a NPN transistor. The first current terminal is the emitter, the second current terminal is the collector and the control terminal is the base of these bipolar transistors. If a single pulse signal from the pulse generator circuit is mixed with a single carrier frequency signal from the oscillator, a single reverser is provided, which is connected to a single MOS transistor controlled by the carrier frequency signal. A single resistor in series with the MOS transistor and the reverser can also be provided for supplying a single mixer circuit output signal. The structure of the mixer circuit can also be used for a radio frequency or UWB signal receiver device.

What is claimed is:

1. A low voltage mixer circuit, particularly for a UWB signal transmission device, the mixer circuit including:
a transconductance stage, which includes a reverser transistor arrangement with an NMOS transistor series-connected with a PMOS transistor between two terminals of a supply voltage source, the drain of the NMOS transistor being connected to the drain of the PMOS transistor to define a transconductance stage output connection node, the gate of the NMOS transistor being connected to the gate of the PMOS transistor for receiving a data signal;
at least one transistor, wherein a first current terminal is connected to a connection node of the transconductance stage, a second current terminal is connected to an impedance for supplying an output signal, and a transistor control terminal is arranged for receiving a signal from an oscillator,
the transistor connected to the connection node of the transconductance stage, and the impedance being series-connected between two terminals of a supply voltage source,
wherein it is integrated in a silicon substrate, wherein the substrate or well potential of the NMOS transistor of the transconductance stage is set at a first potential adapted between the low potential and the high potential of the supply voltage source, and wherein the substrate or well potential of the PMOS transistor of the transconductance stage is set at a second potential adapted between the low potential and the high potential of the supply voltage source.

2. The low voltage mixer circuit according to claim 1, the mixer circuit including:
the transconductance stage with two MOS transistor reverser arrangements, the input of the first reverser arrangement being arranged to receive a first data signal, the output of the first reverser arrangement being a first output connection node of the transconductance stage, the input of the second reverser arrangement being arranged for receiving a second data signal, and the output of the second reverser arrangement being a second output connection node of the transconductance stage,
a first differential pair of MOS transistors of a first type of conductivity, wherein the transistor source is connected to the first connection node of the transconductance stage, the drain of a first transistor of the first differential pair is connected to a first impedance for supplying a first output signal and wherein the drain of a second transistor of the first differential pair is connected to a second impedance for supplying a second output signal,
a second differential pair of MOS transistors of a first type of conductivity, wherein the transistor source is connected to a second connection node of the transconductance stage, the drain of a first transistor of the second differential pair is connected to the second impedance for supplying the second output signal and wherein the drain of a second transistor of the second differential pair is connected to the first impedance for supplying the first output signal,
the gate of each first transistor of the first and second differential pairs being arranged for receiving a first signal from an oscillator, and the gate of each second transistor of the first and second differential pairs being arranged for receiving a second signal from an oscillator,
the differential pairs of transistors connected to the transconductance stage connection nodes, and the impedances being series-connected between two terminals of a supply voltage source.

3. The low voltage mixer circuit according to claim 2, wherein the MOS transistors of the two differential pairs are NMOS transistors.

4. The low voltage mixer circuit according to claim 2, wherein the first impedance is a first resistor, and wherein the second impedance is a second resistor.

5. The low voltage mixer circuit according to claim 2, wherein the first impedance is a first inductance, and wherein the second impedance is a second inductance.

6. The low voltage mixer circuit according to claim 2, wherein the first reverser arrangement includes a first NMOS transistor series-connected with a first PMOS transistor between the two terminals of a supply voltage source, the drain of the first NMOS transistor being connected to the drain of the first PMOS transistor to define the first connection node connected to the first differential pair of transistors, whereas the gate of the first NMOS transistor is connected to the gate of the first PMOS transistor for receiving the first data signal, and wherein the second reverser arrangement includes a second NMOS transistor series-connected with a second PMOS transistor between the two terminals of a supply voltage source, the drain of the second NMOS transistor being connected to the drain of the second PMOS transistor to define the second connection node connected to the second differential pair of transistors, whereas the gate of the second NMOS transistor is connected to the gate of the second PMOS transistor for receiving the second data signal.

7. The low voltage mixer circuit according to claim 6, wherein the substrate or well potential of both NMOS transistors of the transconductance stage is set at the first potential adapted between the low potential and the high potential of the supply voltage source, and wherein the substrate or well potential of both PMOS transistors of the transconductance stage is set at the second potential adapted between the low potential and the high potential of the supply voltage source.

8. The low voltage mixer circuit according to claim 1, wherein it is integrated into a P doped silicon substrate, and wherein the substrate or well potential of the or of both NMOS transistors is set at the low potential of the supply voltage source, whereas the substrate or well potential of the or of both PMOS transistors is at an intermediate level between the low potential and the high potential of the supply voltage source.

9. The low voltage mixer circuit according to claim 1, wherein it is integrated in a P doped silicon substrate in 0.18 μm CMOS technology.

10. A UWB signal transmission device including a pulse generator circuit, which is combined with a data pulse or pulse burst position modulation and phase shift keying unit, a data generator for supplying digital control signals to the pulse generator circuit and the data pulse or pulse burst position modulation and phase shift keying unit, a local oscillator and a mixer circuit according to claim 1 for receiving at least one data signal from the pulse generator circuit to be mixed with at least one carrier frequency signal from the local oscillator so as to supply directly at least one output signal to an antenna for the UWB signal transmission.

11. The UWB signal transmission device according to claim 10, wherein the local oscillator supplies two carrier frequency signals phase shifted by 180° relative to each other, so as to mix each signal in the mixer circuit respectively with a first data signal and a second data signal from the pulse generator circuit, wherein the first data signal is a first pulse output signal, which is modulated with ternary coding, and wherein the second data signal is a second pulse output signal, which is modulated with ternary coding, the second pulse output signal being complementary to the first pulse output signal.
